(19) United States
(12) Patent Application Publication
(10) Pub. No.: US 2025/0200589 A1
(43) Pub. Date: Jun. 19, 2025

(54) DIGITAL SIGNAGE AND GAMING SERVICES TO COMPLY WITH FEDERAL AND STATE ALCOHOL AND BEVERAGE LAWS AND REGULATIONS

(71) Applicant: TOUCHTUNES MUSIC COMPANY, LLC, New York, NY (US)

(72) Inventor: Stephen D. STRAUS, Austin, TX (US)

(21) Appl. No.: 19/068,046

(22) Filed: Mar. 3, 2025

Related U.S. Application Data
(63) Continuation of application No. 18/191,941, filed on Mar. 29, 2023, now Pat. No. 12,271,912.
Application No. 18/191,941 is a continuation of application No. 17/353,851, filed on Jun. 22, 2021, now Pat. No. 11,645,662.
Application No. 17/353,851 is a continuation of application No. 16/386,369, filed on Apr. 17, 2019, now Pat. No. 11,074,593.
Application No. 16/386,369 is a continuation of application No. 12/222,785, filed on Aug. 15, 2008, now Pat. No. 10,290,006.

(51) Int. Cl. G06Q 30/02; G06Q 30/0241; G06Q 30/0251; G06Q 30/0273; G06Q 30/0601

(52) U.S. Cl. CPC G06Q 30/02; G06Q 30/0241; G06Q 30/0248; G06Q 30/0251; G06Q 30/0252; G06Q 30/0259; G06Q 30/0273; G06Q 30/0274; G06Q 30/0277; G06Q 30/0601

(57) ABSTRACT

Methods and systems providing digital signage and interactive gaming services in compliance with federal and state laws and regulations are described. A service fee is collected from a retailer, and a service fee may or may not be collected from a retailer (e.g., a bar). An advertising fee is collected from a first advertising provider. The first advertising provider is involved in alcohol distribution/wholesaling or manufacturing. A second advertising fee from a second advertising provider is collected. The second advertising provider is involved in a non-alcohol related industry. A portion of a subscription fee is collected based on a separate source of fees (e.g., text message or jukebox fee) received from a patron. The message may contain information indicating that the patron wishes to pay a service fee. Revenue sharing is implemented by distributing a portion of the service fee to the retailer and distributing a portion of the advertising fee from the second advertising provider to the retailer in compliance with federal and state laws.

### CROSS-REFERENCE TO RELATED APPLICATION

This application is a Continuation of U.S. application Ser. No. 18/191,941, filed Mar. 29, 2023, which is a Continuation of U.S. patent application Ser. No. 17/353,851, filed Jun. 22, 2021, now U.S. Pat. No. 11,645,662, issued May 9, 2023, which is a Continuation of U.S. patent application Ser. No. 16/386,369 filed Apr. 17, 2019, now U.S. Pat. No. 11,074,593, issued Jul. 27, 2021, which is a Continuation of U.S. patent application Ser. No. 12/222,785 filed Aug. 15, 2008, now U.S. Pat. No. 10,290,006, issued May 14, 2019, the entire contents of all of which are hereby incorporated by reference.

### TECHNICAL FIELD

Certain exemplary embodiments of this invention relate to digital signage and interactive gaming. More particularly, certain exemplary embodiments relate to methods and systems for implementing a business model for digital signage and interactive gaming services in compliance with federal and state laws and regulations related to alcohol distribution.

### BACKGROUND AND SUMMARY

It is desirable to provide entertainment content such as interactive gaming services and digital signage to certain businesses. Businesses requiring these services may be involved with retail establishments in the restaurant and bar business sector that typically serve alcoholic beverages. However, federal and state laws and regulations restrict the amount of interaction between alcohol retailers, alcohol distributors/wholesalers, and alcohol manufacturers. Indeed, such laws and regulations prohibit vertical integration between the various tiers of the system for alcohol distribution. Because of the numerous restrictive laws and regulations that often vary from state-to-state and with the federal government, it has not been possible to provide entertainment content such as interactive gaming services and digital signage to businesses when such entertainment content involves interactions between alcohol retailers, alcohol distributors/wholesalers, and alcohol manufacturers on the one hand, and alcohol retail establishments on the other. Indeed, such restrictive laws and regulations make it difficult even to advertise alcohol-related promotions.

A provider of aggregated content including interactive gaming services and digital signage may implement a revenue sharing model to create incentives for the retail establishment to display such content. Digital signage provides a way for displaying advertisements in a relatively low-cost manner without the typical costs associated with traditional advertising. Advertisements at the national level provided by an advertising provider (e.g., a party not involved with the manufacturing or distribution/wholesaling of alcohol) may then be distributed to retailers to increase advertisement penetration at a local level. The fees collected from these advertising providers (e.g., a party not involved with the manufacturing or distribution/wholesaling of alcohol) may then be shared with retailers to provide incentives for displaying the aggregated content.

The above-noted laws and regulations have presented numerous legal (e.g., compliance) and technical issues that have prevented advertisers, retailers, and alcohol retailers, distributors/wholesalers, and alcohol manufacturers from realizing the full benefits of advertising. For example, the above-noted laws and regulations make it illegal for revenue sharing to be implemented between the parties, for promotions to be run at the retailers on behalf of the alcohol providers, etc. Thus, it will be appreciated that there is a need in the art for techniques that comply with the various applicable federal and state requirements, while also providing some or all of the benefits of advertising, where legal. For example, there is a need in the art for techniques that comply with the various applicable federal and state requirements, while also providing aggregated content. In light of the above-noted federal and state laws related to alcohol distribution, the inventor of the instant invention has discovered that it is possible for aggregated content providers to ensure that revenues from fees collected from alcohol advertisers are not shared with any retailer involved with selling alcoholic beverages as a means of providing advertising and enabling revenue sharing, while also complying with the various applicable federal and state laws. Accordingly, certain exemplary embodiments relate to techniques for ensuring compliance with these federal and state laws and regulations related to alcohol distribution when using digital signage, in a manner that provides some or all of the benefits associated with the same, where legal.

In certain exemplary embodiments, a method and system for providing digital signage are described. In certain exemplary embodiments, the method comprises: receiving advertisements at a data center, where the advertisements to be displayed are based on receipt of advertising fees, wherein at least one of the advertisements is a alcoholic beverage advertisement; sending at least one advertisement from the data center to a display processor via a packet data network; integrating the advertisement in a display window with video using the display processor such that the advertisement appears on a portion of a display in a retail establishment of a retailer while the video is playing and the retail establishment is selling alcoholic beverages and while complying with legal regulations relating to alcoholic beverages.

### BRIEF DESCRIPTION OF THE DRAWINGS

These and other features, aspects, and advantages of the instant invention will be further understood by review of the following detailed description of the exemplary embodiments when read in conjunction with the appended drawings, in which:

FIG. 1 is a data flow diagram of an exemplary embodiment of a process for providing content (e.g., advertisements) as part of digital signage and interactive gaming services in compliance with federal and state alcohol and beverage laws and regulations.

FIG. 2 is a diagram illustrating an exemplary embodiment of a system for digital signage and interactive gaming services.

FIG. 3 is a flow diagram of an exemplary embodiment of a process for aggregating content for digital signage and interactive gaming services.

FIG. 4 is an illustrative computer system usable in connection with an exemplary embodiment.

### DETAILED DESCRIPTION

Certain exemplary embodiments relate to a method and system for displaying advertising and/or other content using digital signage in establishments that sell and serve alcoholic beverages while complying with federal and state alcohol laws and regulations. For example, these laws may be Tied House Laws dealing with on-premises consumption. In certain exemplary embodiments, the system includes a data center to aggregate messages received from retailers and advertising providers to push content in an aggregated form to be displayed at the retailers. A display server hosted by the retailer is then used to overlay the aggregated messages from the data center with a video feed provided by a cable/satellite box. The patrons may then send messages to the data center based on the aggregated content displayed at the retailer to log-in and play to interactive gaming services provided by the data center.

### Overview

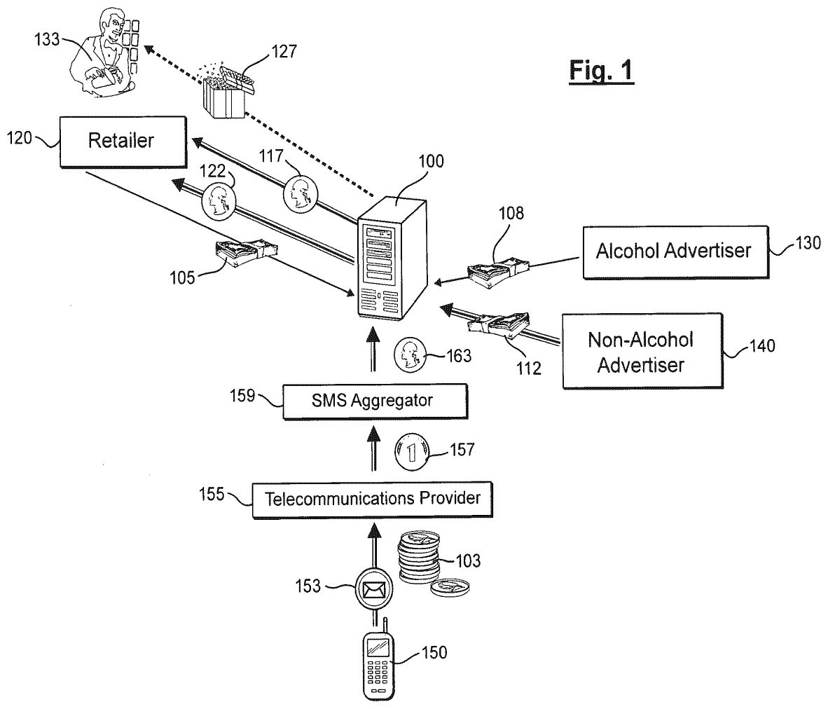

Referring now more particularly to the drawings in which like reference numerals indicate similar components throughout the several views, FIG. 1 is a flow diagram illustrating an exemplary embodiment of a process for providing content (e.g., advertisements) to be displayed using digital signage in compliance with federal and state alcohol and beverage laws and regulations. In certain exemplary embodiments, retailer 120 subscribes to a service provided by data center 100. Retailer 120 may comprise a bar establishment that serves alcoholic beverages and may provide entertainment to clientele including patron 150. Data center 100 may provide interactive gaming and digital signage services for retailer 120. Data center 100 then collects fees via, for example, electronic money transfer from patrons for a collection of services provided by data center 100. For example, data center 100 may provide content including interactive games, messages, and/or advertisements for patrons in the retail establishment of retailer 120. Retailer 120 may then offer these services to customers (e.g., patrons of the bar establishment). For example, retailer 120 may offer an interactive trivia game for a predetermined fee by displaying digital signage to a patron (e.g., patron 150, at the retail establishment of retailer 120). In this manner, the patron may subscribe to the offered service by sending a message 153 to data center 100.

In certain exemplary implementations, patron 150 sends message 153 including subscription information to be received by data center 100. Patron 150 may be a user using a mobile device with SMS capability. Message 153 may be, for example, an SMS message including subscription information sent from the mobile device. The subscription information in message 153 may represent data for indicating that patron 150 is subscribing to the service provided by data center 100. To receive message 153, data center 100 may be a subscriber of services provided by service providers 155 and 159. Message 153 may be sent over a network provided, in part, by service provider 155.

In certain exemplary embodiments, service provider 155 comprises a telecommunications provider that provides a wireless network for transmitting SMS messages. Patron 150 is charged a fee based on the content of the subscription information in message 153. For example, patron 150 may subscribe to an interactive game provided by data center 100 for a predetermined fee 103. Data center 100 sends information to service provider 155 indicating the predetermined fee 103 to be charged and collected from patron 150. Service provider 155 may then collect a portion of the predetermined fee 103 to be distributed to service provider 155 in exchange for transmitting message 153.

In certain exemplary embodiments, service provider 159 may receive message 153 from service provider 155. Service provider 159 may be an SMS aggregator service that functions as an intermediary for service provider 155 and data center 100. In certain exemplary embodiments, service provider 159 aggregates SMS messages sent by patron 150 and other patrons using one or more cell phone providers and forwards the messages to data center 100. Service provider 159 may then collect a portion of a remaining predetermined fee 157 (e.g., a remaining portion of the predetermined fee 103 less the portion distributed to service provider 155) to be distributed to service provider 159 in exchange for aggregating message 153 and messages from other patrons.

In certain exemplary embodiments, data center 100 then receives message 153 forwarded from service provider 159. A remaining predetermined fee 163 (e.g., a remaining portion of the predetermined fee less the portion distributed to service provider 155 and less the portion distributed to service provider 159) then may be collected by and distributed to data center 100. Remaining predetermined fee 163 comprises revenue that data center 100 collects from patron 150. Under the business model, data center 100 may then distribute a portion 117 of the remaining predetermined fee 163 to retailer 120. In this manner, data center 100 may implement revenue sharing with retailer 120 based on fees collected from patrons.

In certain exemplary embodiments, data center 100 receives advertising fee 108 collected from alcohol advertiser 130. Alcohol advertiser 130 comprises, for example, an alcohol beverage manufacturer or an alcohol beverage distributor/wholesaler. In certain exemplary embodiments, data center 100 receives advertising fee 112 collected from non-alcohol advertiser 140. Non-alcohol advertiser 140 may comprise any advertiser that does not include a type of alcohol beverage manufacturer or alcohol beverage distributor/wholesaler. In certain exemplary embodiments, data center 100 shares revenue with retailer 120 taken from a portion of the collected fees from patrons and advertisers. However, revenue sharing is restricted by federal and state laws and regulations when it relates with alcohol distribution. To help ensure compliance with these laws and regulations, data center 100 does not share and/or prevents the sharing of revenue from advertising fee 108 collected from alcohol advertiser 130 with retailer 120. In other words, using data center 100, the business model of certain exemplary embodiments prevents the commingling of revenue from fees collected from alcohol advertisers to be shared with retailers. In contrast, data center 100 may share revenue with retailer 120 collected from the fees from patron 150 and non-alcohol advertiser 140. In addition, data center 100 collects a fee from retailer 120 to comply with these federal and state laws and regulations. In certain exemplary embodiments, data center 100 collects a service fee 105 from retailer 120. Without collecting the service fee 105 from retailer 120 under the revenue sharing business model, in effect, alcohol advertiser 130 would be providing a service to retailer 120 that may be considered of value in certain states in violation of state laws and regulations for alcohol distribution.

In certain exemplary embodiments, data center 100 distributes a portion 122 of the revenue from advertising fee 112 collected from non-alcohol advertiser 140 to retailer 120. Data center 100 may also distribute a portion 117 of the revenue from collected from subscriber 150 to retailer 120. In certain exemplary embodiments, data center 100 distributes non-monetary compensation 127 to employee 133 of retailer 120. Employee 133 may include a bartender or a member of the wait staff employed by retailer 120. Monetary and non-monetary compensation 127 may comprise merchandise, tips, and other benefits distributed to employee 133 (as long as the compensation is not in violation of other laws).

### System for Digital Signage and Interactive Gaming Services

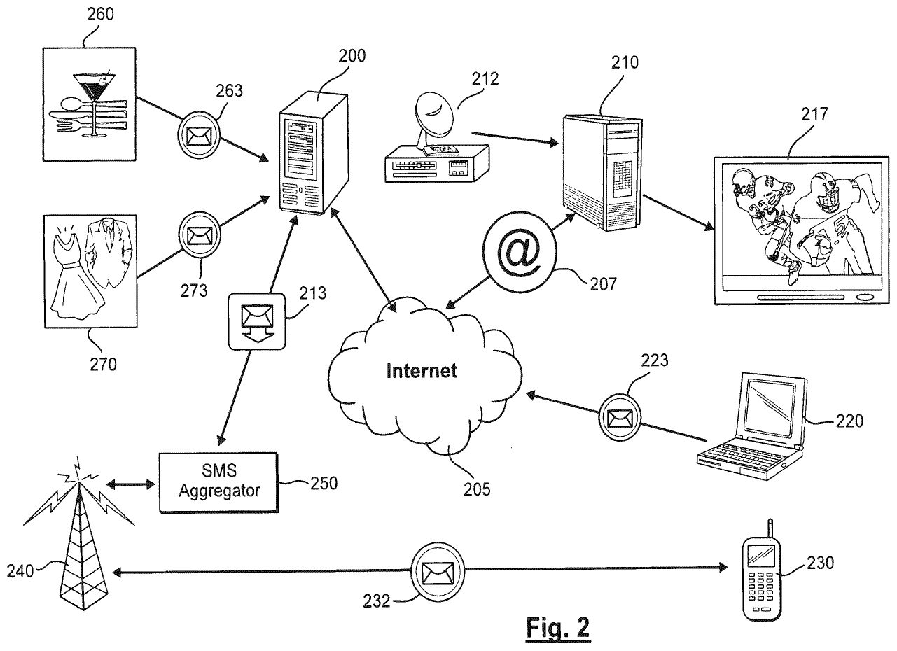

FIG. 2 is a diagram of an exemplary embodiment of a system for digital signage and interactive gaming services. In certain exemplary embodiments, data center 200 provides digital signage content and interactive gaming services for patrons. Data center 200 typically comprises at least one computer system. Data center 200 is coupled to communicate over a network, such as Internet 205. Internet 205 as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

In certain exemplary embodiments, a retailer 120 (e.g., a bar establishment) uses remote client 220 for sending message 223 to data center 200 for processing. Remote client 220 may be a computer system configured to communicate over Internet 205 with data center 200. Message 223 may include content to be displayed on display 217. Display 217 may be a cathode ray tube (CRT) or liquid crystal display (LCD) or any other known display technology in the art. In certain exemplary embodiment, display 217 is a conventional television that accepts a video signal from display server 210. Display server 210 is typically a computer system located at the retailer's site and is coupled to communicate over Internet 205 with data center 200. Display server 210 also is communicably coupled to cable/satellite box 212 or other video source for accepting a video feed provided by cable/satellite box 212. Cable/satellite box 212 is typically a set-top box operable to transmit video feed from a television provider or cable operator that provides content and programming for television video. Display server 210 may transmit a video signal comprising aggregated content to be displayed on display 217. The aggregated content to be displayed may include a video signal comprising digital signage played on the same screen at the same time the video feed provided by cable/satellite box 212 is displayed, where the simultaneous display is done in a manner well-known in the art. In this manner, display server 210 may transmit aggregated content combined from various content providers to be displayed on display 217.

In certain exemplary embodiments, advertising provider 260 sends advertising message 263 to data center 200. Advertising provider 260 may comprise an alcohol manufacturer or alcohol distributor/wholesaler that subscribes to services provided by data center 200. For example, data center 200 may provide a service to display advertising messages from advertising provider 260 in local retail establishments. In this manner, advertising content from a national level may be distributed to the local level with relative case. In certain exemplary embodiments, advertising provider 270 sends advertising message 273 to data center 200. Advertising provider 270 may comprise a non-alcohol related business that also subscribes to services provided by data center 200. For example, advertising provider 270 may include a clothes manufacturer, a retail chain, sports memorabilia manufacturer, or sports franchise. In this manner, data center 200 may have patrons involved in alcohol distribution and patrons not involved with alcohol distribution.

In certain exemplary embodiments, subscriber 230 may send message 232 over a network provided by service provider 240. Subscriber 230 may be using a mobile device with SMS capability for sending messages over the network. Service provider 240 may be a telecommunications provider that provides communications services for subscriber 230. In certain exemplary embodiments, service provider 240 may then forward message 232 to SMS aggregator 250. SMS aggregator 250 typically provides a service to receive SMS messages from various different service providers and forwards the messages to a subscriber of the SMS aggregator service, which is data center 200 in this case. SMS aggregator 250 may then forward message 232 to data center 200 for processing. Data center 200 may provide a service to subscriber 230 based on the information in message 232. Data center 200 may then transmit response message 213 to subscriber 230 in response to message 232. Response message 213 may comprise a confirmation message acknowledging that subscriber 230 has successfully subscribed to the service provided by data center 200.

In certain exemplary embodiments, data center 200 may combine advertising message 263, advertising message 273, and message 223 to be transmitted as an aggregated message 207 to display server 210. Data center 200 acts as a “hub” for the “spokes” including the various providers of content. Data center 200 may then segregate and process the messages received from these various providers of content in a manner compliant with federal and state laws and regulations related to alcohol distribution. After receiving aggregated message 207, display server 210 processes aggregated message 207 to display the content in aggregated message 207 on the same screen at the same time as the video feed received from cable/satellite box 212. In this manner, aggregated content comprised of the video feed from cable/satellite box 212 and aggregated message 207 is displayed on display 217.

### Method for Displaying Aggregated Content for Digital Signage

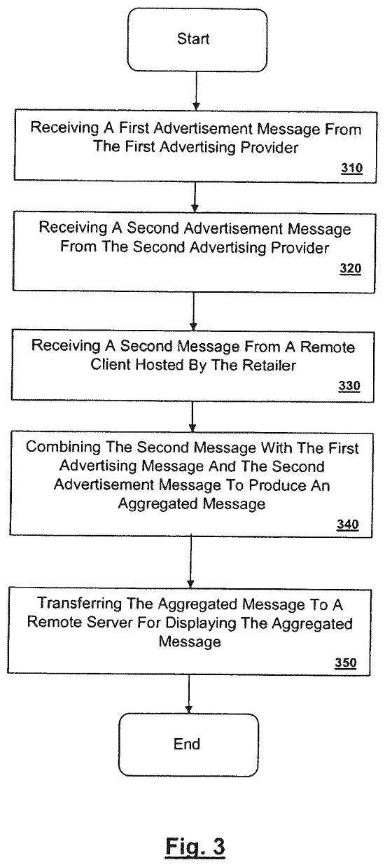

FIG. 3 is a block diagram of an exemplary embodiment of a process for aggregating content for digital signage and interactive gaming services performed by the system. Referring to FIG. 3, processing logic in the system receives a first advertisement message from a first advertising provider (processing block 310). First advertising provider may comprise an alcohol related advertiser. At processing block 320, processing logic in the system receives a second advertisement message from a second advertising provider. The second advertising provider may comprise a non-alcohol related advertiser. Next, at processing block 330, processing logic receives a second message from a remote client located at a retailer. The retailer may be a patron of services provided by the system. Then, processing logic in the system combines the second message with the first advertising message and the second advertisement message to produce an aggregated message (processing block 340). In this manner, the system produces aggregated content that may be displayed. At processing block 350, processing logic in the system transfers the aggregated message to a remote server for displaying the aggregated message. In certain exemplary embodiments, the remote server is located at the retailer.

### An Exemplary Computer System

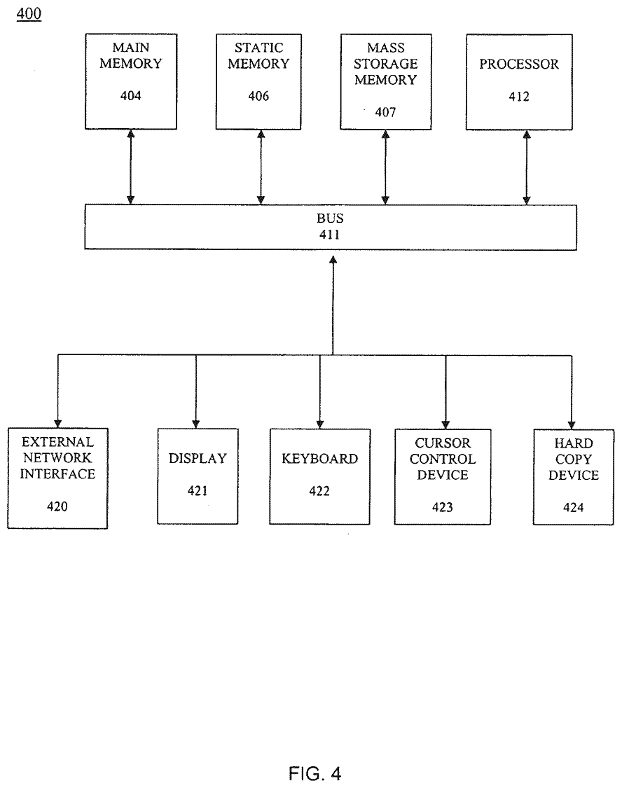

FIG. 4 is a block diagram of a computer system that may perform one or more of the operations described herein according to an exemplary embodiment. Referring to FIG. 4, computer system 400 may comprise an exemplary client or server computer system. Computer system 400 comprises a communication mechanism or bus 411 for communicating information, and a processor 412 coupled with bus 411 for processing information. Processor 412 includes a microprocessor, but is not limited to a microprocessor, such as, for example, Pentium™, PowerPC™, Alpha™, etc.

System 400 further comprises a random access memory (RAM), or other dynamic storage device 404 (referred to as main memory) coupled to bus 411 for storing information and instructions to be executed by processor 412. Main memory 404 also may be used for storing temporary variables or other intermediate information during execution of instructions by processor 412.

Computer system 400 also comprises a read only memory (ROM) and/or other static storage device 406 coupled to bus 411 for storing static information and instructions for processor 412, and a data storage device 407, such as a magnetic disk or optical disk and its corresponding disk drive. Data storage device 407 is coupled to bus 411 for storing information and instructions.

Computer system 400 may further be coupled to a display device 421, such as a cathode ray tube (CRT) or liquid crystal display (LCD), coupled to bus 411 for displaying information to a computer user. An alphanumeric input device 422, including alphanumeric and other keys, may also be coupled to bus 411 for communicating information and command selections to processor 412. An additional user input device is cursor control 423, such as a mouse, trackball, trackpad, stylus, or cursor direction keys, coupled to bus 411 for communicating direction information and command selections to processor 412, and for controlling cursor movement on display 421.

Another device that may be coupled to bus 411 is hard copy device 424, which may be used for marking information on a medium such as paper, film, or similar types of media. Another device that may be coupled to bus 411 is a wired/wireless communication capability 425 to communication to a phone or handheld palm device.

Note that any or all of the components of system 800 and associated hardware may be used in connection with certain exemplary embodiments of the present invention. However, it will be appreciated that other configurations of the computer system may include some or all of the devices.

The processes described herein may be a machine-readable medium having stored thereon data and instructions to cause a programmable processor to perform operations as described above. In certain exemplary embodiments, the operations might be performed by specific hardware components that contain hardwired logic. Those operations might alternatively be performed by any combination of programmed computer components and custom hardware components. As such, the exemplary embodiments described herein may be implemented in connection with any suitable combination of programmed logic circuitry (e.g., hardware, software, firmware, and/or the like).

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (“ROMs”), random access memories (“RAMs”), erasable, programmable read-only memories (“EPROMs”), electrically-erasable read-only memories (“EEPROMs”), Flash memories, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that improved keystroke dynamic authentication can also be achieved by software and hardware that distribute the functions of embodiments of this invention differently than herein described. Such variations and implementations are understood to be captured according to the following claims. Furthermore, it will be appreciated that the features, aspects, advantages, and exemplary embodiments described herein may be combined in any combination or sub-combination to yield yet further exemplary embodiments.

It will be appreciated that the fees described above may or may not be charged in certain exemplary embodiments. It also will be appreciated that the same or different fee may be charged to each of the parties that is charged a fee. Indeed, the exemplary embodiments described herein may be extended such to any scheme in which money is taken from patrons and given to retailers, while any money taken from alcohol retailers or manufacturers/distributors does not go to the retailer directly or indirectly (e.g., is not directly or indirectly tied to an alcoholic brand or product).

Also, although certain exemplary embodiments have been described in relation to taking a percentage of the cost of sending a message such as a text message, the present invention is not so limited. For example, the fees that fund the various parties may be generated in whole or in part from any combination of acceptable non-alcohol producing or distributing agent or apparatus such as, for example, a jukebox (e.g., as a portion of the fee charged for playing music), a bar-top device (e.g., as a portion of the fee charged for playing a game), a handheld gaming device, and/or the like. Additionally, the advertisements may be displayed on any acceptable display device including, for example, overhead displays, large televisions, jukeboxes, bar-top devices, handheld gaming devices, etc.

While the preferred aspects of the invention have been illustrated and described herein, it will be apparent to one of ordinary skill in the art that various changes and/or modifications can be made. Thus, the specific description herein is meant to be exemplary only and is not intended to limit the invention beyond the terms of appended claims.

What is claimed is:

1. A method of providing advertisements to a retail establishment, the method comprising:
receiving, from a packet data network and at a data center via a computer system including at least one processor, advertisement messages to be displayed, wherein the advertisement messages comprise a first set of advertisement messages, each advertisement message in the first set of advertisement messages being displayable at one or more display devices in retail establishments for a first fee;
combining the advertisement messages to be displayed to produce a set of aggregated messages;
sending the set of aggregated messages to the retail establishment and/or other retail establishments,
causing the aggregated message to be integrated in a display window with a streaming video signal, using a display processor, such that the advertisement messages appear on a portion of a display in the retail establishment while the video signal is playing and the retail establishment is selling alcoholic beverages;
collecting, on behalf of the data center, the first fees for advertisement messages in the first set of advertisement messages; and
preventing any portion of the first fee collected for the one of the first set of advertisement messages from being shared with retail establishment(s) at which the associated advertisement messages are displayed in order to comply with legal regulations relating to alcoholic beverages,
wherein the legal regulations relating to alcoholic beverages pertain to how revenue from alcoholic beverage related advertisements may be shared among different parties involved in such advertisements.

2. The method of claim 1, wherein the advertisement messages to be displayed further comprise a second set of electronic advertisement messages, each said advertisement message in the second set of advertisement messages being unrelated to alcohol and being displayable at one or more display devices in retail establishments for a second fee.

3. The method of claim 1, further comprising:
receiving a third set of messages from one or more individuals at a retail establishment of a retailer located remote from the data center, the third set of messages including content to be displayed on one or more display devices in the retail establishment, wherein the third set of messages is included in the set of aggregated messages.

4. The method of claim 1, further comprising charging a service fee to retail establishment(s) at which the first set of advertisement messages are displayed to compensate the data center for complying with applicable laws regarding alcohol-related advertisements.

5. The method of claim 1, further comprising, in response to determination that the one of the first set of advertisement messages is related to alcohol, preventing commingling of fees received for in the one of the first set of advertisement messages, with other received fees.

6. The method of claim 1, further comprising collecting fees from patrons at the retail establishments for interacting with display of advertisement messages.

7. The method of claim 6, further comprising sharing a portion of the fees from the patrons with the respective retail establishment from which the fee was collected.

8. The method of claim 6, further comprising sharing a portion of the fees from the patrons with an employee at the respective retail establishment from which the fee was collected.

9. The method of claim 6, further comprising using a portion of the fees from the patrons to provide non-monetary awards/rewards to an employee at the respective retail establishment from which the fee was collected.

10. A method of providing advertisements, the method comprising:
receiving, at a data center, advertisement messages to be displayed based on receipt of advertising fees, wherein the advertisements comprise a first advertisement message received from a first advertising provider through a packet data network, the first advertisement message being alcohol-related and being displayable at a display device in retail establishments;
combining the advertisement messages to be displayed to produce an aggregated message; and
sending the aggregated message from the data center to a display processor via the packet data network, the aggregated messages being integratable in a display window with a streaming video signal,
wherein a service fee is collected from a retailer and the first advertisement message is shown on the display device based on advertisement fees while complying with legal regulations relating to alcoholic beverages, and the legal regulations relating to alcoholic beverages pertain to how revenue from alcoholic beverage related advertisements may be shared.

11. The method of claim 10, wherein the advertisement messages to be displayed further comprise a second advertisement message from a second advertising provider through the packet data network, the second advertisement message being unrelated to alcohol and being displayable at one or more display devices in retail establishments for a second fee.

12. The method of claim 10, further comprising:
receiving at the data center a third message from a remote client at a retail establishment of a retailer located remote from the data center, the third message including content to be displayed on the display device in the retail establishment, wherein the third message is included in the aggregated message.

13. The method of claim 12, wherein the third message from the remote client in the retail establishment is in response to content seen by the remote client on the display device at the retail establishment.

14. The method of claim 12, wherein receiving the third message from the remote client in the retail establishment comprises:
receiving, at the data center, the third message, the third message having been forwarded from a telecommunications tower after having been wirelessly sent to said telecommunications tower from the remote client.

15. The method of claim 11, wherein a first service provider and a second service provider share revenue based on the transmission of messages.

16. The method of claim 15, wherein the first service provider comprises an SMS aggregator service provider and the second service provider comprises a telecommunications service provider.

17. The method of claim 10, wherein the first advertisement message is received from an alcoholic beverage advertiser.

18. The method of claim 17, wherein a first advertising fee associated with the first advertisement message from the first advertising provider is not to be distributed to a retailer.

19. The method of claim 11. wherein the first and second advertisement messages are received from the Internet.
